(19) United States
(12) Patent Application Publication
(10) Pub. No.: US 2025/0054124 A1
(43) Pub. Date: Feb. 13, 2025

(54) VEHICLE COMPONENT REPAIR PREDICTION

(71) Applicant: Treads App, Inc., Park City, UT (US)

(72) Inventor: Zach Olson, Park City, UT (US)

(21) Appl. No.: 18/446,306

(22) Filed: Aug. 8, 2023

(51) Int. Cl. G06T 7/00; G06Q 10/20

(52) U.S. Cl. CPC G06T 7/0004; G06Q 10/20; G06T 2207/20084

(57) ABSTRACT

An apparatus includes a processor and a memory that stores code executable by the processor to receive an image of a tire, determine a location of damage on the tire, classify the damage as a damage type, and predict whether the tire is repairable based at least in part on the location and the damage type.

### FIELD

The subject matter disclosed herein relates generally to the repair or replacement of vehicle components, and more specifically to predicting when a vehicle component needs repair or replacement.

### BACKGROUND

Certain vehicle components, such as tires, are replaced at certain intervals or repaired when needed to reduce safety risks. A number of factors can contribute to tire damage (e.g., degradation), such as driving style, load, climate, quality, road condition, and the like. Some types of tire damage can be repaired. However, tires that are damaged beyond a certain point cannot be repaired and must be replaced. Predicting when a tire requires repair or replacement can be difficult.

### BRIEF SUMMARY

An apparatus for vehicle component repair is disclosed. The apparatus, in one example, includes a processor and a memory that stores code executable by the processor. The code is executable by the processor to receive an image of a tire, identify damage on the tire, determine a location of the damage on the tire, classify the damage as a damage type, and predict whether the tire is repairable based at least in part on the location and damage type.

Disclosed herein is an apparatus comprising a processor and a memory that stores code executable by the processor to receive an image of a tire, determine a location of damage on the tire, classify the damage as a damage type, and predict whether the tire is repairable based at least in part on the location and the damage type. The preceding subject matter of this paragraph characterizes example 1 of the present disclosure.

The type of the damage comprises at least one of a bubble, a puncture, a blowout, a flat, a bulge, a crack, a cut, irregular wear, regular wear, or any combination thereof. The preceding subject matter of this paragraph characterizes example 2 of the present disclosure, wherein example 2 also includes the subject matter according to example 1, above.

The code is executable by the processor to input the image into an artificial intelligence model and classify the type of damage based at least in part on an output of the artificial intelligence model. The preceding subject matter of this paragraph characterizes example 3 of the present disclosure, wherein example 3 also includes the subject matter according to any of examples 1-2, above.

The code is executable by the processor to input the image into an artificial intelligence model and determine the location of the damage based at least in part on an output of the artificial intelligence model. The preceding subject matter of this paragraph characterizes example 4 of the present disclosure, wherein example 4 also includes the subject matter according to any of examples 1-3, above.

The code is executable by the processor to determine whether the location of the damage is within a repairable zone of the tire. The preceding subject matter of this paragraph characterizes example 5 of the present disclosure, wherein example 5 also includes the subject matter according to any of examples 1-4, above.

The repairable zone comprises a zone on a surface area of the tire that is between a first side of the tire and a second side of the tire opposite of the first side. The preceding subject matter of this paragraph characterizes example 6 of the present disclosure, wherein example 6 also includes the subject matter according to example 5, above.

The code is further executable by the processor to predict that the tire is not repairable in response to determining whether the location of the damage is within a repairable zone of the tire. The preceding subject matter of this paragraph characterizes example 7 of the present disclosure, wherein example 7 also includes the subject matter according to any of examples 5-6, above.

The code is executable by the processor to determine a confidence score and determine that the confidence score is greater than or equal to a threshold confidence score. The preceding subject matter of this paragraph characterizes example 8 of the present disclosure, wherein example 8 also includes the subject matter according to any of examples 1-7, above.

The code is executable by the processor to receive the image from a user via a mobile application, and, in response to determining that the confidence score is greater than or equal to a threshold confidence score, automatically transmit a notification comprising an appointment request from the user to a technician or salesperson. The preceding subject matter of this paragraph characterizes example 9 of the present disclosure, wherein example 9 also includes the subject matter according to example 8, above.

The appointment request comprises an appointment type and the code is executable by the processor to determine an appointment type based at least in part on determining whether the tire is repairable. The preceding subject matter of this paragraph characterizes example 10 of the present disclosure, wherein example 10 also includes the subject matter according to example 9, above.

The apparatus further comprises a graphical user interface (GUI), wherein the code is executable by the processor to output at least one of the following to the GUI: an indication that the tire is repairable based at least in part on predicting that the tire is repairable, an indication that the tire is not repairable based at least in part on predicting that the tire is not repairable, the confidence score, or any combination thereof. The preceding subject matter of this paragraph characterizes example 11 of the present disclosure, wherein example 11 also includes the subject matter according to any of examples 8-10, above.

The GUI is configured to receive input from the user to transmit an appointment request to a technician or a salesperson. The preceding subject matter of this paragraph characterizes example 12 of the present disclosure, wherein example 12 also includes the subject matter according to example 11, above.

The code is further executable by the processor to determine that the damage type is a non-repairable damage type and to predict that the tire is not repairable in response to the location of damage. The preceding subject matter of this paragraph characterizes example 13 of the present disclosure, wherein example 13 also includes the subject matter according to any of examples 1-12, above.

Additionally disclosed herein is a method comprising receiving an image of a tire, identifying damage on the tire, determining a location of the damage on the tire, classifying the damage as a damage type, and predicting whether the tire is repairable based at least in part on the location and the damage type. The preceding subject matter of this paragraph characterizes example 14 of the present disclosure.

The method further comprises inputting the image into an artificial intelligence model. The classifying is based at least in part on an output of the artificial intelligence model. The preceding subject matter of this paragraph characterizes example 15 of the present disclosure, wherein example 15 also includes the subject matter according to example 14, above.

The method further comprises inputting at least one of the location of the damage and the damage type into an artificial intelligence model. The predicting is based at least in part on an output of the artificial intelligence model. The preceding subject matter of this paragraph characterizes example 16 of the present disclosure, wherein example 16 also includes the subject matter according to any of examples 14-15, above.

Classifying the damage further comprises detecting an object puncturing the tire and determining a type of the object. The preceding subject matter of this paragraph characterizes example 17 of the present disclosure, wherein example 17 also includes the subject matter according to any of examples 14-16, above.

Further disclosed herein is a system. The system comprises a mobile computing device. The system also comprises a mobile application comprising computer program code executing on the mobile computing device. The computer program code is executable to receive an image of a tire. The system further comprises a remote computing device in communication with the mobile application. The remote computing device comprises a processor and a memory that stores code executable by the processor to receive the image from the mobile application, identify damage on the tire, determine a location of the damage on the tire, classify the damage as a damage type, input the location and damage type into an artificial intelligence (AI) model, generate a prediction of whether the tire is repairable based at least in part on an output of the AI model, and transmit the prediction to the mobile device. The preceding subject matter of this paragraph characterizes example 18 of the present disclosure.

Also disclosed herein is a program product comprising a computer readable storage medium that stores code executable by a processor. The executable code comprises code to perform receiving an image of a tire, identifying damage on the tire, determining a location of the damage on the tire, classifying the damage as a damage type, and predicting whether the tire is repairable based at least in part on the location and the damage type. The preceding subject matter of this paragraph characterizes example 19 of the present disclosure.

Further disclosed herein is a method that comprises receiving an image of a component of a vehicle. The method also comprises receiving data from a mobile device of a user, the data comprising motion of the mobile device over a time interval while the mobile device is within the vehicle. The method further comprises determining, based at least in part on the data, a plurality of accelerations of the mobile device over the time interval. The method additionally comprises determining a number of accelerations of the plurality of accelerations. Each acceleration of the number of accelerations is greater than or equal to a threshold acceleration. The method also comprises determining a quantity of the number of accelerations. The method further comprises inputting a quantity of the number of accelerations into an artificial intelligence (AI) model. The method additionally comprises inputting a quantity of the number of accelerations into an artificial intelligence (AI) model. The method also comprises predicting at least one of a future repair or a future replacement of the component based at least in part on the image and on the predicted degree of component degradation. The method further comprises prompting, through an application on the mobile device and based at least in part on the determining, the user to schedule an appointment with a technician on or after the future date and time. The preceding subject matter of this paragraph characterizes example 20 of the present disclosure.

The component comprises at least one of a tire or a brake pad of the vehicle. The preceding subject matter of this paragraph characterizes example 21 of the present disclosure, wherein example 21 also includes the subject matter according to example 20, above.

Each acceleration of the plurality of accelerations comprises a change in velocity of the mobile device over a smaller time interval within the time interval. The preceding subject matter of this paragraph characterizes example 22 of the present disclosure, wherein example 22 also includes the subject matter according to example 21, above.

### BRIEF DESCRIPTION OF THE DRAWINGS

A more particular description of the examples briefly described above will be rendered by reference to specific examples that are illustrated in the appended drawings. Understanding that these drawings depict only some examples and are not therefore to be considered to be limiting of scope, the examples will be described and explained with additional specificity and detail through the use of the accompanying drawings, in which:

FIG. 1 is a schematic block diagram illustrating one example of a system for predicting repairability of a vehicle component;

FIG. 2 is a schematic block diagram illustrating one example of an apparatus for predicting repairability of a vehicle component;

FIG. 3 is a schematic block diagram illustrating another example of an apparatus for predicting repairability of a vehicle component;

FIG. 4 illustrates one example of a user interface on a computing device configured to predict repairability of a vehicle component;

FIG. 5 illustrates another example of a user interface on a computing device showing a repairability prediction for a vehicle component;

FIG. 6 illustrates yet another example of a user interface on a computing device showing a repairability prediction for a vehicle component;

FIG. 7 illustrates one example of a user interface on a computing device showing another repairability prediction and a markup of a damage location of a vehicle component;

FIG. 8 illustrates one example of a user interface on a computing device showing a non-repairable prediction for a vehicle component;

FIG. 9 illustrates one example of a user interface on a computing device showing another non-repairable prediction for a vehicle component;

FIG. 10 illustrates one example of a user interface on a computing device showing another non-repairable prediction for a vehicle component with a higher confidence level than with the prediction shown in FIG. 9;

FIG. 11 illustrates one example of a repairable zone for a damaged tire;

FIG. 12 is a schematic flow chart diagram illustrating one example of a method of predicting repairability of a vehicle component;

FIG. 13 is a schematic flow chart diagram illustrating one example of a method for predicting repairability of a vehicle component and scheduling an appointment with an corresponding type of service provider; and

FIG. 14 is a schematic block diagram illustrating one example of an apparatus for predicting degradation of a vehicle component.

### DETAILED DESCRIPTION

As will be appreciated by one skilled in the art, aspects of the examples may be embodied as a system, method or program product. Accordingly, examples may take the form of an entirely hardware example, an entirely software example (including firmware, resident software, micro-code, etc.) or an example combining software and hardware aspects that may all generally be referred to herein as a “circuit,” “module” or “system.” Furthermore, examples may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain example, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for examples may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one example,” “an example,” or similar language means that a particular feature, structure, or characteristic described in connection with the example is included in at least one example. Thus, appearances of the phrases “in one example,” “in an example,” and similar language throughout this specification may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the examples may be combined in any suitable manner. In the following description, numerous specific details are provided, such as examples of programming, software modules, user selections, network transactions, database queries, database structures, hardware modules, hardware circuits, hardware chips, etc., to provide a thorough understanding of examples. One skilled in the relevant art will recognize, however, that examples may be practiced without one or more of the specific details, or with other methods, components, materials, and so forth. In other instances, well-known structures, materials, or operations are not shown or described in detail to avoid obscuring aspects of an example.

Aspects of the examples are described below with reference to schematic flowchart diagrams and/or schematic block diagrams of methods, apparatuses, systems, and program products according to examples. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various examples. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding examples. Indeed, some arrows or other connectors may be used to indicate only the logical flow of the depicted example. For instance, an arrow may indicate a waiting or monitoring period of unspecified duration between enumerated steps of the depicted example. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate examples of like elements.

An apparatus for vehicle component repair is disclosed. The apparatus, in one example, includes a processor and a memory that stores code executable by the processor. The code is executable by the processor to receive an image of a tire, identify damage on the tire, determine a location of the damage on the tire, classify the damage as a damage type, and predict whether the tire is repairable based at least in part on the location and damage type.

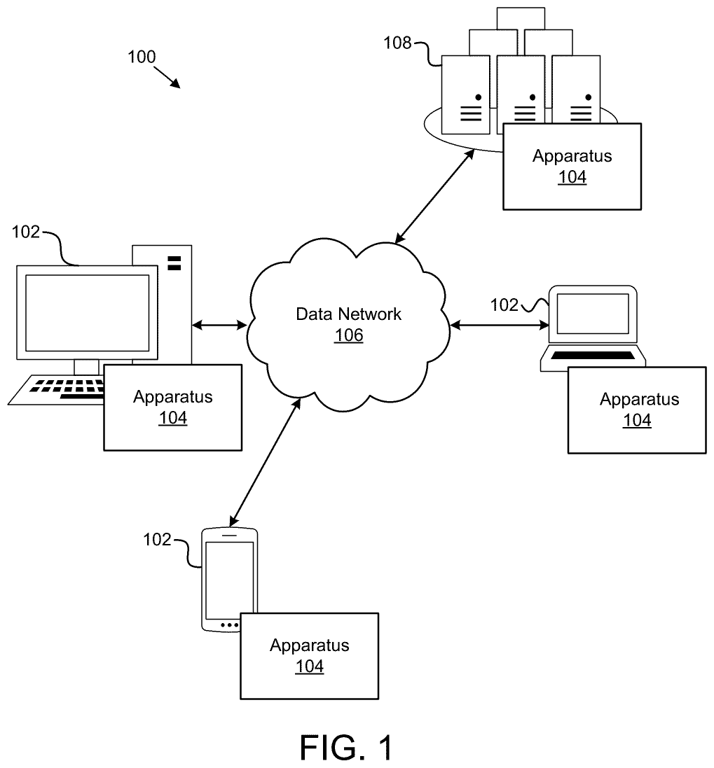

FIG. 1 is a schematic block diagram illustrating one example of a system 100 for predicting repairability of a vehicle component, such as a tire. As shown in FIG. 1, the system 100 includes a repairability prediction apparatus 104 (otherwise known as “the apparatus 104”), which may be part of any one of a number of information handling devices 102 and/or a server 108. As shown in FIG. 1, the information handling devices 102 and the server 108 are communicably connected via a data network 106.

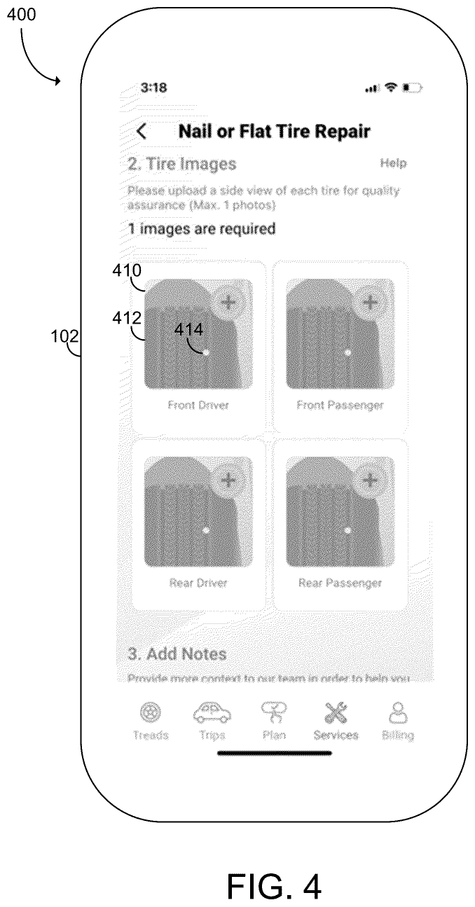

In some examples, the user inputs information via the one or more information handling device 102. For example, the user submits an image 410 of a tire 412 via a mobile application on the information handling device 102 (see, e.g., FIG. 4). The apparatus 104, which is part of the information handling device 102 and/or the remote server 108 connected to the information handling device 102 over the data network 106, receives the image 410. The functions described herein as being performed by the apparatus 104 can be performed on either an information handling device 102 or a server 108.

The repairability prediction apparatus 104, in such an example, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one example, the repairability prediction apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the repairability prediction apparatus 104.

The semiconductor integrated circuit device or other hardware appliance of the repairability prediction apparatus 104, in certain examples, includes and/or is communicatively coupled to one or more volatile memory media, which may include but is not limited to random access memory (“RAM”), dynamic RAM (“DRAM”), cache, or the like. In one example, the semiconductor integrated circuit device or other hardware appliance of the repairability prediction apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one example, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one example, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one example, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. For instance, a server 108 may be an intermediary between information handling devices 102 to facilitate sending and receiving electronic messages between the information handling devices 102.

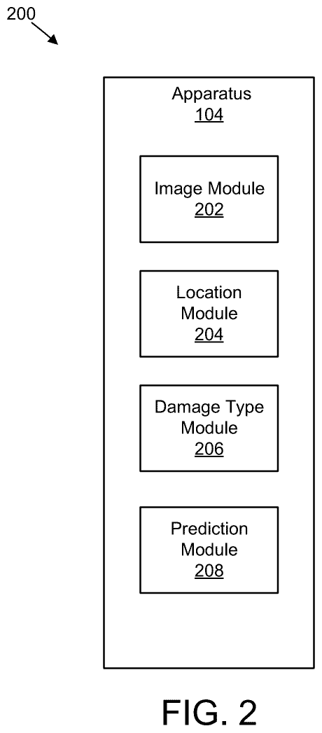

FIG. 2 is a schematic block diagram illustrating one example of an apparatus 200 for predicting repairability of a vehicle component. The apparatus 200 includes an example of the repairability prediction apparatus 104. The repairability prediction apparatus 104, in some examples, includes one or more of an image module 202, a location module 204, a damage type module 206, and a prediction module 208, which are described in more detail below.

In some examples, the image module 202 is configured to receive an image (e.g., image 410 of FIG. 4) of a vehicle component, such as a tire 412. A vehicle component can be or include, for example, any of various components of a car, truck, bicycle, motorcycle, motor vehicle, and/or aircraft. In one example, as illustrated herein, the vehicle component is a tire, such as the tire 412, of an automobile. In some examples, the image module 202 is also configured to receive types of information relating to the vehicle component other than an image. For example, the image module 202 receives an audio and/or text description of the vehicle component and/or of the damage to the vehicle component.

In some examples, the image 410 includes an image uploaded to a mobile application of the apparatus 200. In some examples, the image 410 includes an image captured by a camera of an information handling device 102 within the mobile application. In some examples, the image module 202 is configured to transmit the image 410 from the information handling device 102 to a remote server 108 and/or to another information handling device 102 connected to the data network 106.

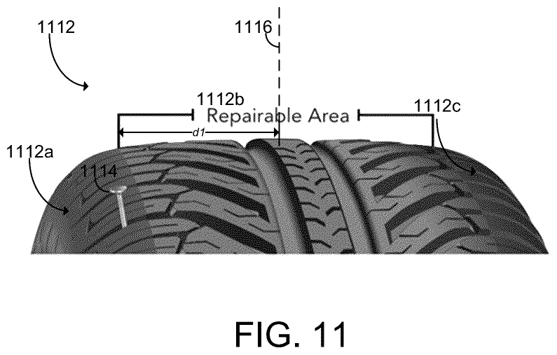

The apparatus 200 includes a location module 204 configured to determine a location of damage on the vehicle component. For example, based on the image 410, the location module 204 determines a position and/or area of damage on the surface area of the tire 412. In some examples, determining the location of damage includes identifying a zone of a tire that includes the damage. For example, as shown in FIG. 11, a tire 1112 includes multiple zones 1112a, 1112b, 1112c. The location module 204 can thus be configured to determine that the damage (e.g., an object 1114 puncturing the tire 1112) is located in one or more of the zones 1112a, 1112b, 1112c.

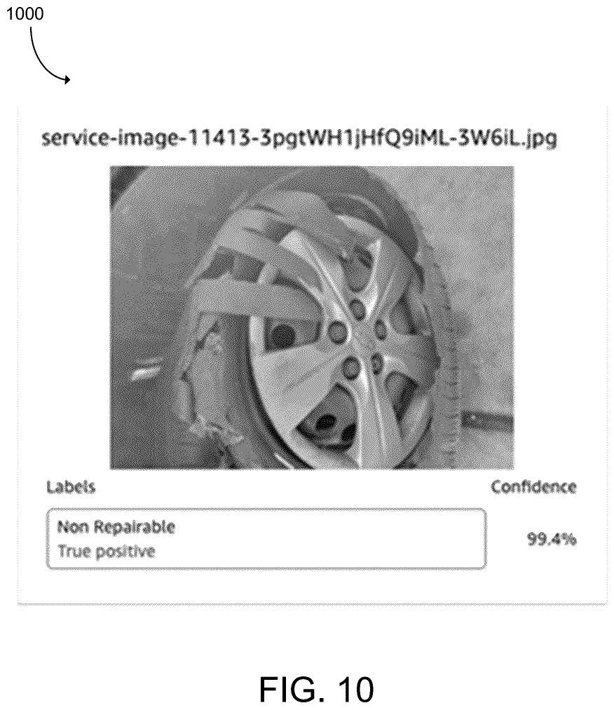

Damage to the component includes, for example, at least one of a bubble, a puncture by an object 414, a blowout (e.g., as shown in FIG. 10), a flat, a bulge 914, a crack, a cut, irregular wear, normal wear, or any combination thereof. The apparatus 200 includes a damage type module 206 that is configured to classify the damage as a damage type. For example, the damage type module 206 can classify the damage as a damage type based on an input from a user and/or based on a comparison of the damage to predefined data. In some examples, the damage type module 206 analyzes the image 410 to determine the damage type. For example, the damage type module 206 compares the image 410 to a database of images of different damage types and classifies the damage type based on the comparison.

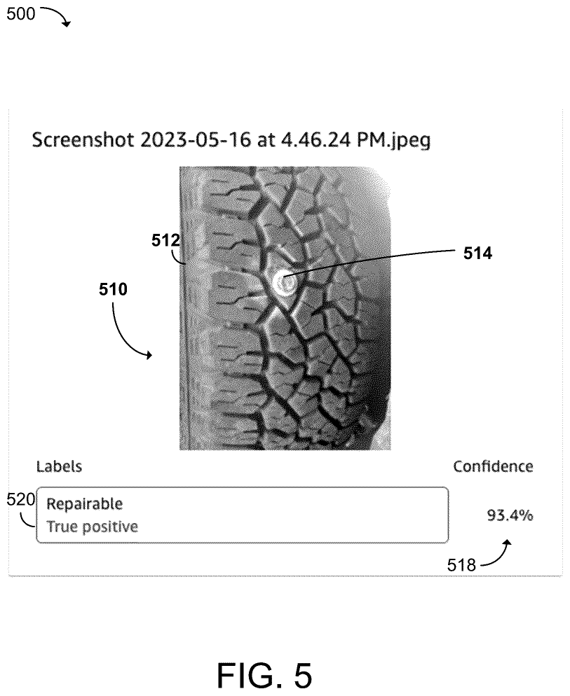

In some examples, the damage type module 206 is configured to detect an object other than the vehicle component in the uploaded image in order to classify the damage type. For example, as shown in FIG. 5, the image 510 of the tire 512 includes an object 514 puncturing the tire 512. The damage type module 206 is configured to identify the object 514 and classify the damage as a punctured tire based at least in part on the identified object 514. In some examples, the damage type is further based on the type of object 514.

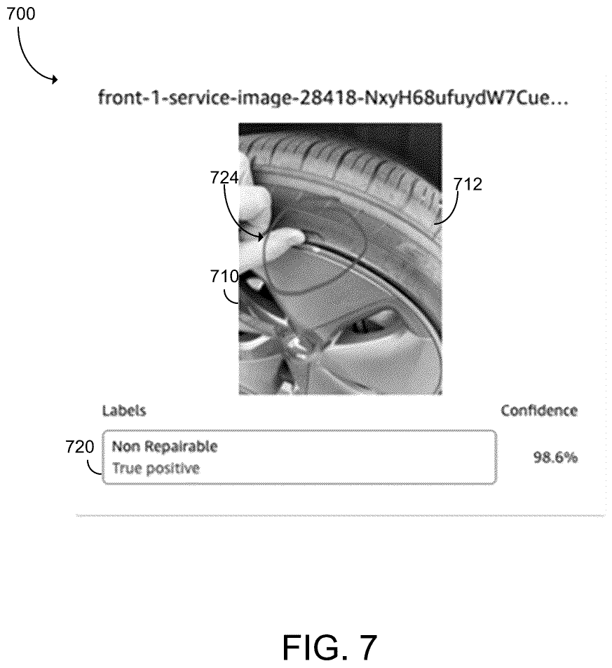

In some examples, the damage type module 206 is configured to classify the type of damage based at least in part on markings on the image from the user. For example, as shown in FIG. 7, the image 710 includes a mark 724 circling the damage to the tire 512. In other examples, the graphical user interface (“GUI”) 700 is configured to receive input from the user that identifies damage in the image 710. For example, the user circles and/or highlights an area of damage on the image 710 manually (e.g., through a touch screen and/or cursors) using the information handling device 102 after uploading the image 710 to a mobile and/or web application.

The apparatus 200 includes a prediction module 208 configured to predict whether the vehicle component is repairable based at least in part on the location determined by the location module 204 and the damage type determined by the damage type module 206. For example, referring to FIG. 11, the prediction module 208 determines that the damage is located in an area of the tire (e.g., tire 1112) that is not repairable (e.g., zones 1112a, 1112c) or that is repairable (e.g., zone 1112b).

In some examples, the prediction module 208 determines that the type of damage determined by the damage type module 206 is an unrepairable damage type. For example, the prediction module 208 accesses a database of repairable and/or unrepairable damage types. For example, as shown in FIG. 10, the damage type is a blown out tire. The prediction module 208 identifies “blown out tire” as an unrepairable damage type and predicts that the tire 1012 is unrepairable.

In some examples, the damage type is a repairable damage type, but the location of the damage is an unrepairable zone 1112a, 1112c. The prediction module 208 predicts that the damage is not repairable based on the location. In other examples, the location of damage is an unrepairable zone 1112b, but the damage type is an unrepairable damage type. The prediction module 208 predicts that the damage is no repairable based on the damage type.

In some examples, the damage type and/or damage location is a “sometimes repairable” damage type/damage location. In such examples, the prediction module 208 considers the combination of the damage type and the damage location. For example, the damage type module 206 and/or the damage location module 204 outputs a percentage of such damage types and/or damage locations that are repairable, and the prediction module 208 predicts repairability based on that percentage.

In some examples, the prediction module 208 predicts repairability based on a comparison of the vehicle component to past successful and/or unsuccessful repairs inputted by a service technician. In some examples, the prediction module 208 compares an image 410 to other images classified as “repairable” or “unrepairable” and predicts repairability based at least in part on that comparison.

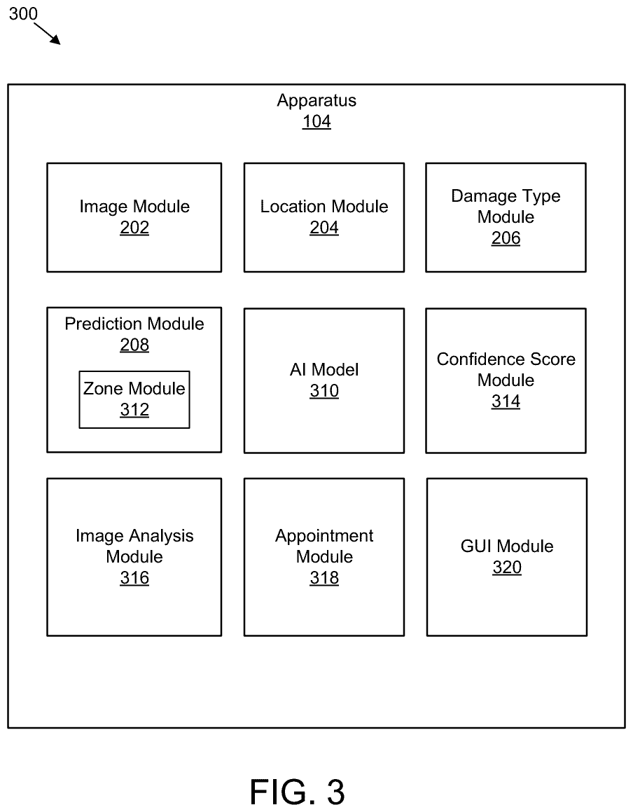

FIG. 3 is a schematic block diagram illustrating one example of an apparatus 300 for predicting repairability. In one example, the apparatus 300 includes an example of a repairability prediction apparatus 104. The repairability prediction apparatus 104, in some examples, includes one or more of an image module 202, location module 204, damage type module 206, and prediction module 208, as described in connection with the apparatus 200 of FIG. 2. In some examples, the apparatus 300 also includes one or more of an artificial intelligence (AI) model 310, a zone module 312, a confidence score module 314, an image analysis module 316, an appointment module 318, and a GUI module 320.

In some examples, the apparatus 300 includes the AI model 310. In some examples, the AI model 310 includes a machine learning model. The damage type module 206 inputs the image 410 into the AI model 310 and classifies the damage type based at least in part on an output of the AI model 310.

In some examples, the location module 204 inputs the image 410 into the AI model 310 and determines the location of the damage on the component based at least in part on an output of the AI model 310.

In some examples, the prediction module 208 includes a zone module 312 that is configured to determine whether the location of the damage is within a repairable zone (e.g., zone 1112b) of the tire. For example, the zone module 312 determines that a tire 1112 is punctured by an object 1114. In some examples, the repairable zone 1112b includes the surface area of the tire 1112 that is within a distance d1 of a center line 1116 of the tire 1112, which is a line that is substantially perpendicular to an axis of rotation of the tire 1112. The unrepairable zones 1112a, 1112c are the areas of the tire 1112 that are outside of the distance d1 from the center line 1116. For example, the repairable zone 1112b is a zone on a surface area of the tire 1112 that is between a first side 1118a of the tire 1112 and a second side 1118b opposite to the first side 1118a.

In some examples, the zone module 312 is configured to determine whether the zone is a repairable zone based at least in part on output from the AI model 310. For example, the AI model 310 analyzes multiple images having unrepairable and repairable damage and learns repairable and unrepairable zones based at least in part on that analysis. When the image 410 is input into the AI model 310, the AI model 310 recognizes the damage and determines whether the zone is a repairable or unrepairable zone. For example, upon receiving an image of the tire 1112, the AI model 310 identifies the damage as the object 1114 puncturing the tire 1112 and flags the location of the object 1114 as an unrepairable zone 1112a of the tire 1112.

In some examples, the confidence score module 314 is configured to determine a confidence score for the prediction made by the prediction module 208. The confidence score includes a likelihood that the prediction is correct, which, in some examples, is expressed as a percentage. As shown in FIG. 5, in some examples, the user interface 500 shows the confidence score 518 as a percentage. The confidence score is determined based on, for example, a quality of the submitted image, the damage type, the location of the damage, data besides the image input by the user, comparison to other images, or any combination thereof. For example, the damage type is a damage type that is sometimes repairable and sometimes not repairable, and the confidence score is low. In other examples, the damage type is a damage that is almost always not repairable, and the confidence score for the prediction that the damage is not repairable is high.

In some examples, the image analysis module 316 is configured to receive an image of the vehicle component (e.g., image 410 in FIG. 4) from the user via a mobile application. The image analysis module 316 determines a quality of the image. For example, if the image is of low resolution and/or part of the vehicle component being imaged is obscured in the image, the image analysis module 316 determines that the quality of the image is low, and the confidence score module 314 predicts a low confidence score.

In some examples, the confidence score module 314 is configured to compare the confidence score to a threshold confidence score. The confidence score module 314 determines whether the confidence score is equal to or greater than the threshold confidence score. For example, the threshold confidence score is a pre-set value. In some examples, the threshold confidence score is input by a user of the mobile application. In other examples, the threshold confidence score is input by a personnel of a tire servicing company.

In some examples, an appointment module 318 is configured to schedule appointments for vehicle component repair and/or replacement with a technician. For example, both the technician and the user are users of the mobile application. In some examples, the confidence score module 314 determines that the confidence score is greater than or equal to the threshold confidence score. In response, the appointment module 318 automatically schedules an appointment for either repair or replacement of the component. As one of many examples, if the confidence score module 314 determines that the confidence score for a prediction of not repairable is 97%, which is greater than a threshold confidence score of 95%, the appointment module 318 transmits a notification from the user to a tire salesperson. The tire salesperson can be registered in the mobile application as a tire salesperson. As another one of many examples, if the confidence score module 314 determines that the confidence score for a prediction of repairable is 97%, which is greater than a threshold confidence score of 95%, the appointment module 318 transmits a notification from the user to a tire repair technician. The tire repair technician can be registered in the mobile application as a tire repair technician. The notification includes a request for an appointment. In some examples, the notification includes a request for an appointment at a date and time specified by the user. In other examples, the notification includes a prompt for the salesperson of technician to select a date and time. In some examples, the appointment module 318 compares an availability of the user to an availability of one or more salespersons or technicians and selects overlapping availability. For example, the appointment module 318 accesses a user's calendar from another application, such as a calendar application on an information handling device. In other examples, the users input their availability directly into the mobile application.

In some examples, the appointment module 318 determines an appointment type based on the prediction from the prediction module 208. The appointment type includes, for example, repair appointment, replacement appointment, diagnostic appointment, or any combination thereof. For example, the prediction module 208 predicts that a tire 712 is not repairable, as shown in FIG. 7. The notification to the technician includes an appointment type “Tire Replacement.” In another example, the prediction module 208 predicts that a tire 512 is repairable, as shown in FIG. 5. The notification to the technician includes an appointment type “Tire Repair.”

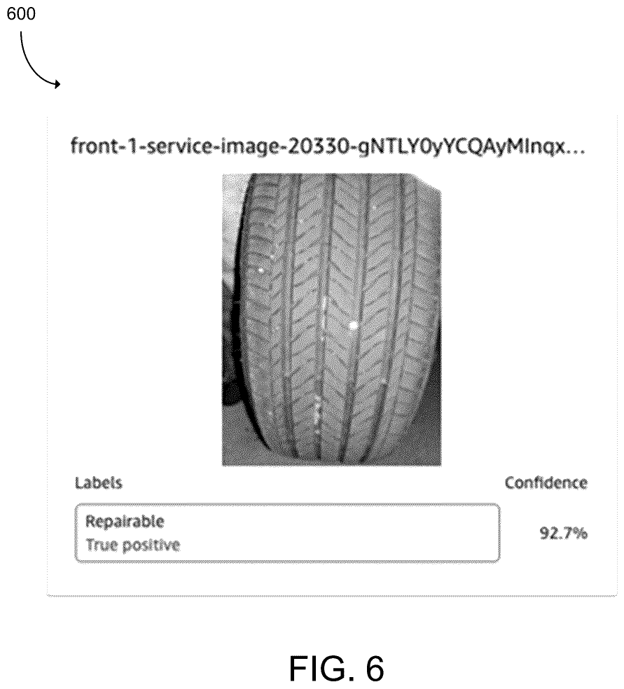

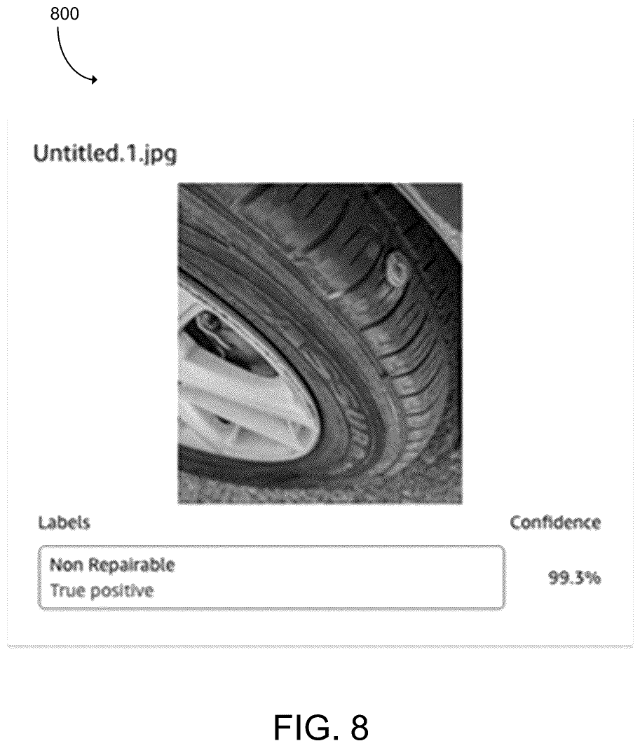

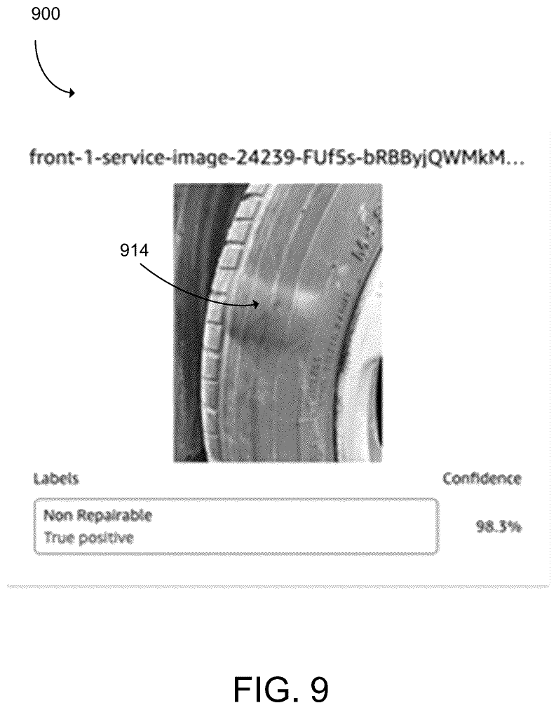

In some examples, the GUI module 320 is configured to output information to a graphical user interface (“GUI”) of an information handling device 102. For example, FIGS. 4-10 illustrate examples 400-1000 of GUIs in accordance with the present disclosure. In some examples, the GUI module 320 is configured to output predictions from the prediction module 320. For example, as shown in FIG. 5, the GUI module 320 outputs the prediction 520 that the tire 512 is repairable to the GUI 500. As shown in FIG. 5, the GUI module 320 is also configured to output the confidence score 518 to the GUI 500. In another example, in FIG. 7, the GUI module 320 outputs the prediction 720 that the tire 712 is not repairable to the GUI 700.

In some examples, the GUI module 320 is also configured to receive input from the user regarding next steps after outputting the prediction from the prediction module. For example, the GUI prompts the user to schedule an appointment and receives input from the user through a “Schedule Now” button and/or a “Schedule Later” button. After the GUI module 320 receives input from the user to schedule the appointment, the appointment module 318 transmits an appointment request to a technician.

In some examples, the GUI module 320 also receives input from the user via a GUI. For example, as shown in FIG. 4, the user uploads photos 410 of a damaged tire 412 via a GUI 400 to be analyzed by the repairability prediction apparatus 104. In some examples, the user can also input other information via the GUI 400, such as text entry containing notes regarding the damage.

FIGS. 4-10 illustrate examples of user interfaces 400, 500, 600, 700, 800, 900, 1000 that support repairability prediction in accordance with aspects of the present disclosure. In some examples, the user interface 400, 500, 600, 700, 800, 900, 1000 may implement aspects of system 100. The user interface may be an application on a computing device (e.g., a mobile application on a mobile computing device 102) and may enable a user to access a repairability prediction apparatus 104 as described herein. As shown in FIG. 4, the user interface 400 receives input (e.g., images 410) from the user. As shown in FIGS. 5-10, the user interface 500 outputs a repairability prediction, confidence score, or any combination thereof.

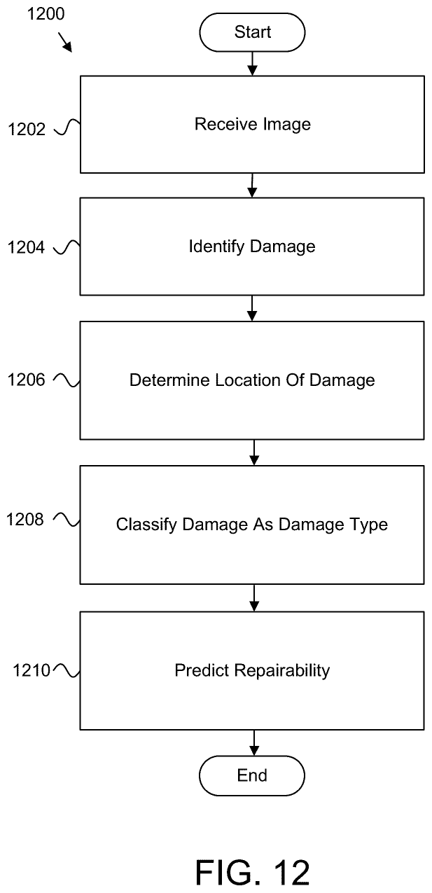

FIG. 12 is a schematic flow chart diagram illustrating one example of a method for 1200 predicting repairability of a vehicle component, such as a tire. In one example, the method 1200 begins and receives 1202 an image of a component of a vehicle. The method 1200 identifies 1204 damage on the vehicle component and determines 1206 a location of the damage on the component. The method 1200 classifies 1208 the damage as a damage type and predicts 1210 whether the tire is repairable based at least in part on the location of the damage and the damage type, and the method 1200 ends. In various examples, the image module 202, the location module 204, the damage type module 206, and the prediction module 208 perform the various steps of the method 1200.

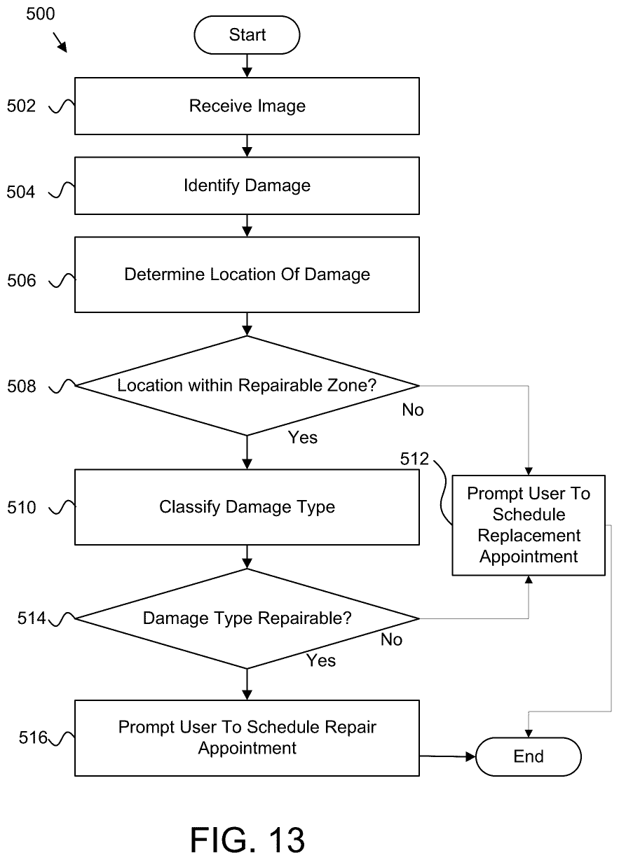

FIG. 13 is a schematic flow chart diagram illustrating one example of a method 1300 for predicting repairability of a vehicle component and scheduling an appointment. The method 1300 begins and receives 1302 an image of a component of a vehicle. The method 1300 identifies 1304 damage on the vehicle component and determines 1306 a location of the damage on the component. The method 1300 determines 1308 whether the location is within a repairable zone of the vehicle component. If so, the method 1300 classifies 1310 the damage type. If not, the method 1312 prompts the user to schedule an appointment to replace the component, and the method 1300 ends.

After the method 1300 classifies 1310 the damage type, the method 1300 determines 1314 whether the damage type is repairable. If the damage type is not repairable, the method 1312 prompts the user to schedule an appointment to replace the component, and the method 1300 ends. If the damage type is repairable, the method 1300 prompts 1316 the user to schedule a repair appointment, and the method 1300 ends.

In various examples, the image module 202, the location module 204, the damage type module 206, prediction module 208, zone module 312, AI model 310, confidence score module 314, image analysis module 316, appointment module 318, and GUI module 320 perform the various steps of the method 1300.

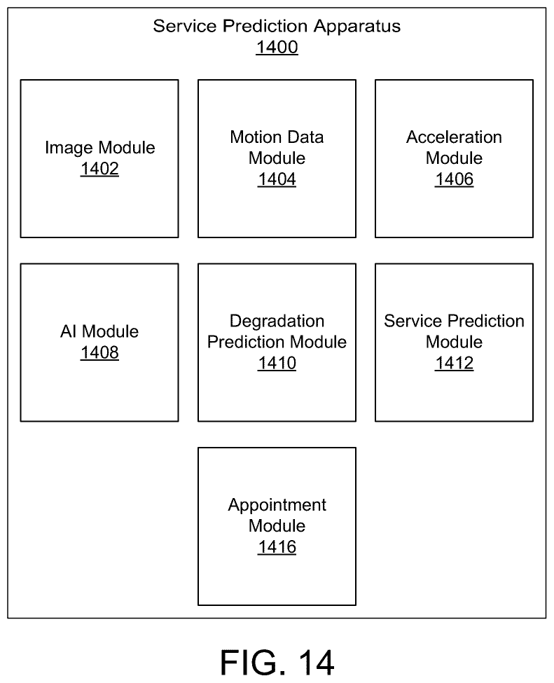

FIG. 14 is a schematic block diagram illustrating one example of an apparatus 1400 for predicting degradation of a vehicle component. The apparatus 1400 includes, in some examples, one or more of an image module 1402, a motion data module 1404, an acceleration module 1406, an AI module 1408, a degradation prediction module 1410, a service prediction module 1412, and an appointment module 1416.

In some examples, the image module 1402 is configured to receive an image (e.g., image 410 of FIG. 4) of a vehicle component. For example, the vehicle component includes a tire 412 or a brake pad.

In some examples, the motion data module 1404 is configured to receive data from an information handling device (e.g., devices 102) of a user of the vehicle. For example, the motion data module 1404 receives data from a mobile device of the user. The data includes motion of the mobile device over a time interval while the mobile device is within the vehicle. As such, in such examples, the data includes motion of the vehicle while the mobile device is within the vehicle. The mobile device collects the motion data, for example, via sensors in the mobile device. In some examples, the motion data module 1404 receives the motion data via GPS of the mobile device.

In some examples, the acceleration module 1406 is configured to determine, based at least in part on the motion data, a plurality of accelerations of the mobile device during the time interval and/or a number of additional time intervals. For example, the acceleration module 1406 analyzes motion data across a “test period” of 30 days. The motion data module 1404 collects the motion data for each driving period of the user in the vehicle during those 30 days. The motion data module 1404 does not collect motion data from the mobile device when the mobile device is external to the vehicle.

As used herein, the term “accelerations” includes changes in the velocity and/or speed of the mobile device over a smaller time interval within the time interval. For example, an “acceleration” analyzed by the acceleration module 1408 includes an acceleration over ten seconds during a ten-minute drive. An “acceleration”, for example, includes changes in velocity resulting from a traffic light turning from red to green, the driver turning a corner, braking, accelerating to pass another vehicle, reversing, or any combination thereof.

In some examples, the acceleration module 1408 is configured to determine a number of the accelerations that is greater than or equal to a threshold acceleration. For example, the threshold acceleration is ±3 m/s². The acceleration module 1408 determines a quantity of these accelerations. For example, the acceleration module 1408 determines that there are ten accelerations that exceed the threshold acceleration.

In some examples, the artificial intelligence (“AI”) module 1408 is configured to input the number of accelerations from the acceleration module 1408 and a specified future data and time into an artificial intelligence model that outputs, based at least in part on the quantity of the number of accelerations and/or on the degree of the accelerations, a predicted degree of degradation at the specified date and time. In some examples, the artificial intelligence module 1408 includes a machine learning model that analyzes and determines likely trends in degradation for drivers with certain driving patterns. For example, the AI module of the AI module 1408 analyzes quality of vehicle components over time for drivers with certain driving habits (e.g., degree/frequency of acceleration) and predicts a degree of degradation from a baseline state (e.g., the state of the component as pictured in the image received by the image module 1402) based at least in part on learned trends.

In some examples, the degradation prediction module 1410 is configured to predict a degree of degradation of the vehicle component. In some examples, the degradation prediction module 1410 is configured to predict the degree of degradation based at least in part on output from the AI module 1408.

In some examples, the service prediction module 1412 is configured to predict a future service and/or replacement date for the component. For example, the service prediction module 1412 analyzes the state of health of the component based at least in part on the image received by the image module 1402 and/or a state of health determination made by the image module 1402. The service prediction module 1412 predicts a future state of health of the component based at least in part on the degradation prediction module 1410. In some examples, the degradation module 1410 outputs a predicted state of health over time for the component, and a decrease in the state of health is considered a degradation. The service prediction module 1412 predicts a future service and/or replacement appointment based on the predicted state of health at a future date being at or below a threshold state of health. In some examples, the service prediction module 1412 predicts a future service and/or replacement appointment based at least in a part on a frequency of service and/or replacement appointments by other drivers with similar driving habits, as determined by the AI module 1408.

In some examples, the appointment module 1416 is configured to prompt the user to schedule an appointment to repair and/or replace the component based at least in part on the service prediction by the service prediction module 1412. In some examples, the appointment module 1416 prompts the user through an application on an information handling device 102, such as a user interface of a mobile device, to schedule an appointment on, near, or after the predicted service date.

Examples may be practiced in other specific forms. The described examples are to be considered in all respects only as illustrative and not restrictive. The scope of the subject matter disclosed herein is, therefore, indicated by the appended claims rather than by the foregoing description. All changes which come within the meaning and range of equivalency of the claims are to be embraced within their scope.

1. An apparatus, comprising:
a processor; and
a memory that stores code executable by the processor to:
receive an image of a tire;
determine a location of damage on the tire;
classify the damage as a damage type; and
predict whether the tire is repairable based at least in part on the location and the damage type.

2. The apparatus of claim 1, wherein the type of the damage comprises at least one of a bubble, a puncture, a blowout, a flat, a bulge, a crack, a cut, irregular wear, regular wear, or any combination thereof.

3. The apparatus of claim 1, wherein the code is executable by the processor to input the image into an artificial intelligence model and classify the type of damage based at least in part on an output of the artificial intelligence model.

4. The apparatus of claim 1, wherein the code is executable by the processor to input the image into an artificial intelligence model and determine the location of the damage based at least in part on an output of the artificial intelligence model.

5. The apparatus of claim 1, wherein the code is executable by the processor to determine whether the location of the damage is within a repairable zone of the tire.

6. The apparatus of claim 5, wherein the repairable zone comprises a zone on a surface area of the tire that is between a first side of the tire and a second side of the tire opposite of the first side.

7. The apparatus of claim 5, wherein the code is further executable by the processor to predict that the tire is not repairable in response to determining whether the location of the damage is within a repairable zone of the tire.

8. The apparatus of claim 1, wherein the code is executable by the processor to determine a confidence score and determine that the confidence score is greater than or equal to a threshold confidence score.

9. The apparatus of claim 8, wherein the code is executable by the processor to:
receive the image from a user via a mobile application; and
in response to determining that the confidence score is greater than or equal to a threshold confidence score, automatically transmit a notification comprising an appointment request from the user to a technician or salesperson.

10. The apparatus of claim 9, wherein the appointment request comprises an appointment type and the code is executable by the processor to determine an appointment type based at least in part on determining whether the tire is repairable.

11. The apparatus of claim 8, further comprising a graphical user interface (GUI), wherein the code is executable by the processor to output at least one of the following to the GUI: an indication that the tire is repairable based at least in part on predicting that the tire is repairable, an indication that the tire is not repairable based at least in part on predicting that the tire is not repairable, the confidence score, or any combination thereof.

12. The apparatus of claim 11, wherein the GUI is configured to receive input from the user to transmit an appointment request to a technician or a salesperson.

13. The apparatus of claim 1, wherein the code is further executable by the processor to determine that the damage type is a non-repairable damage type and to predict that the tire is not repairable in response to the location of damage.

14. A method, comprising:
receiving an image of a tire;
identifying damage on the tire;
determining a location of the damage on the tire;
classifying the damage as a damage type; and
predicting whether the tire is repairable based at least in part on the location and the damage type.

15. The method of claim 14, further comprising inputting the image into an artificial intelligence model, wherein the classifying is based at least in part on an output of the artificial intelligence model.

16. The method of claim 14, further comprising inputting at least one of the location of the damage and the damage type into an artificial intelligence model, wherein the predicting is based at least in part on an output of the artificial intelligence model.

17. The method of claim 14, wherein classifying the damage further comprises detecting an object puncturing the tire and determining a type of the object.

18. A program product comprising a computer readable storage medium that stores code executable by a processor, the executable code comprising code to perform:
receiving an image of a tire;
identifying damage on the tire;
determining a location of the damage on the tire;
classifying the damage as a damage type; and
predicting whether the tire is repairable based at least in part on the location and the damage type.
